(19) United States
(12) Patent Application Publication
(10) Pub. No.: US 2015/0229549 A1
(43) Pub. Date: Aug. 13, 2015

(54) SYSTEMS AND METHODS FOR AUTOMATED SERVICE PROPAGATION

(71) Applicant: MONOLITH TECHNOLOGY SERVICES, INC., St. Charles, IL (US)

(72) Inventor: Shawn Patrick Ennis, Plano, TX (US)

(73) Assignee: MONOLITH TECHNOLOGY SERVICES, INC., St. Charles, IL (US)

(21) Appl. No.: 14/179,686

(22) Filed: Feb. 13, 2014

(51) Int. Cl. H04L 12/26; H04L 12/24

(52) U.S. Cl. CPC H04L 43/08; H04L 41/50

(57) ABSTRACT

Systems and methods for automatically propagating service definitions from service fulfillment platforms. The systems and methods receive service information associated with a new service one or more service templates in response to receiving service information. The systems and methods then identify a service template associated with the service information and instantiate the service template and deploying the service associated with the service information. Finally, the systems and methods configure monitoring for the service associated with the service information and generate monitoring information for the service associated with the service information.

### CROSS-REFERENCE TO RELATED APPLICATIONS

This application is related to commonly-owned applications: Ser. No. 13/099,572, published as U.S. Patent Pub. No. 2012/0284008, now abandoned; Ser. No. 13/104,663, published as 2012/0290707; Ser. No. 13/099,449, published as U.S. Patent Pub. No. 2012/0284326, now abandoned; Ser. No. 13/099,430, published as U.S. Patent Pub. No. 2012/0284391, now abandoned; and Ser. No. 13/116,066, published as U.S. Patent Pub. No. 2012/0303772. The subject matter of the preceding related applications is incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present disclosure relates generally to service monitoring. More particularly, the present disclosure relates to systems and methods for automated monitoring services for new network products and services using topology templates.

2. Description of Related Art

Network operators routinely deploy new services utilizing existing or new network infrastructure. As part of these deployments an operator or administrator generally configures each network endpoint (e.g., routers, switches, etc.) and various service parameters including service level agreements. Due to the complexity involved in even the most rudimentary networks this process is increasingly burdensome and requires detailed knowledge of nearly every aspect of the network and the service itself ranging from physical network characteristics to application-level details of the service. In addition to these concerns, operators or administrators must additionally handle “secondary” concerns such as network event monitoring and other performance analyses.

The disclosure addresses the shortcomings of these approaches by providing an automated solution for deploying services on a network. Specifically, the disclosure describes a technique for receiving service information and instantiating service templates using the service information. This automated technique addresses the problems describe above by abstracting service details into predefined templates which allow network operators or administrators to focus on the service-specific details (e.g., endpoints and SLAs) while allowing the service template to coordinate the deployment and monitoring of individual network elements and the service in general.

### SUMMARY OF THE INVENTION

The present disclosure describes methods, systems, and non-transitory computer readable media for automatically propagating service definitions from service fulfillment platforms.

Specifically, one embodiment of the system described herein comprises a service template storage module for storing service template and a monitoring service module for monitoring information for the service associated with the service information.

The system further comprises a configuration server. The configuration server is operative to receive service information and one or more service templates in response to receiving service information. The configuration server then identifies a service template associated with the service information and instantiates the service template. The configuration server further deploys the service associated with the service information and configures monitoring for the service associated with the service information.

The disclosure further describes a method for automatically propagating service definitions from service fulfillment platforms. The method receives service information associated with a new service one or more service templates in response to receiving service information.

The method then identifies a service template associated with the service information and instantiates the service template and deploying the service associated with the service information. Finally, the method configures monitoring for the service associated with the service information and generates monitoring information for the service associated with the service information.

Furthermore, the present disclosure is directed towards a non-transitory computer readable media comprising program code that when executed by a programmable processor causes execution of a method for automatically propagating service definitions from service fulfillment platforms. The computer program code receives service information associated with a new service one or more service templates in response to receiving service information.

The computer program code then identifies a service template associated with the service information and instantiates the service template and deploying the service associated with the service information. Finally, the computer program code configures monitoring for the service associated with the service information and generates monitoring information for the service associated with the service information.

In alternative embodiments, the service information comprises one of a customer identifier, service identifier, service levels, customer access information to portals, end point data, and metadata relating to a service. In another embodiment, identifying a service template associated with the service information comprises matching a network topology to the type of service identified by the service information. In another embodiment, the system, method and non-transitory computer readable media may receive a decommissioning request for the new service and terminate said monitoring which may comprise storing historical data gathering during the monitoring. In some embodiments, monitoring comprises passive or active monitoring.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates automating service propagation monitoring according to one embodiment of the disclosure;

FIG. 2 illustrates a method for transmitting service information for a new service according to one embodiment of the disclosure;

FIG. 3 illustrates a method for deploying a network service according to one embodiment of the disclosure;

FIG. 4 illustrates a method for decommissioning a service according to one embodiment of the disclosure; and

FIGS. 5A-C illustrate graphical user interfaces for the instantiation of service templates according to one embodiment of the disclosure.

### DETAILED DESCRIPTION OF THE INVENTION

In the following description of the embodiments of the disclosure, reference is made to the accompanying drawings that form a part hereof, and in which is shown by way of illustration exemplary embodiments in which the invention may be practiced. It is to be understood that other embodiments may be utilized and structural changes may be made without departing from the scope of the disclosed invention.

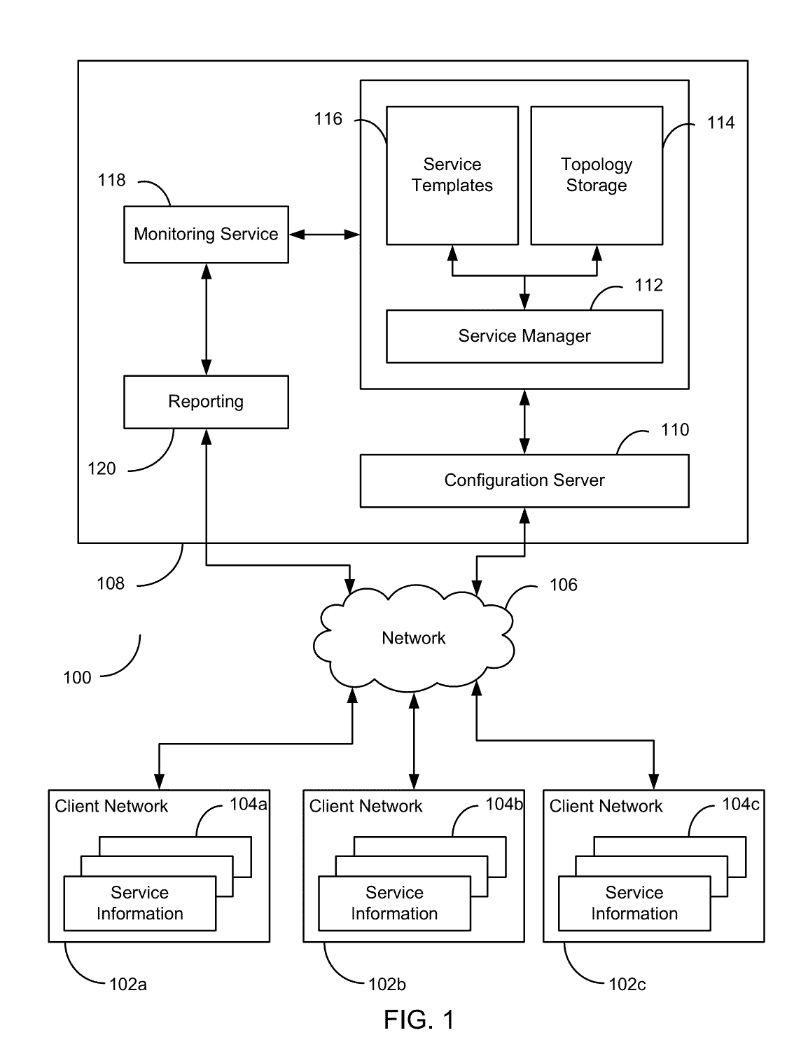

FIG. 1 illustrates automating service propagation monitoring according to one embodiment of the disclosure. As illustrated in FIG. 1, a plurality of client networks 102a-c containing service information 104a-c connected to a network 106, such as the Internet. A service fulfillment provider 108 is connected to the network 106 and contains a configuration server 110, a topology manager 112, topology storage 114, topology templates 116, monitoring server 118, and reporting server 102. Although device 110-120 are illustrated as single device, alternative embodiments exist wherein the functionality of the devices 110-120 are implemented using multiple devices.

As the embodiment of FIG. 1 illustrates, a plurality of client networks 102a-c contain service information 104a-c. As illustrated, the client networks 102a-c may comprise “customer” networks containing network elements (not pictured) such as routers, switches, and the like. These network elements may be configured to provide various pre-existing services supplied by the customer to end users of the customer such a voice and/or data services. A customer may transmit network details, full or partial, to the service fulfillment provider 108 via an interface provided by the provider 108. Such details may include the network elements within the client networks 102a-c and the connections between said elements on various network layers.

Client networks 102a-c contain service information 104a-c. In the illustrated embodiment, service information 104a-c comprises information relating to the details of services to be deployed on the network infrastructure. For example, service information may contain a customer identifier, service identifier, service definitions including service levels, customer access information to portals, end points (e.g., network devices, interfaces, partitions, etc.), and various other metadata relating to a service.

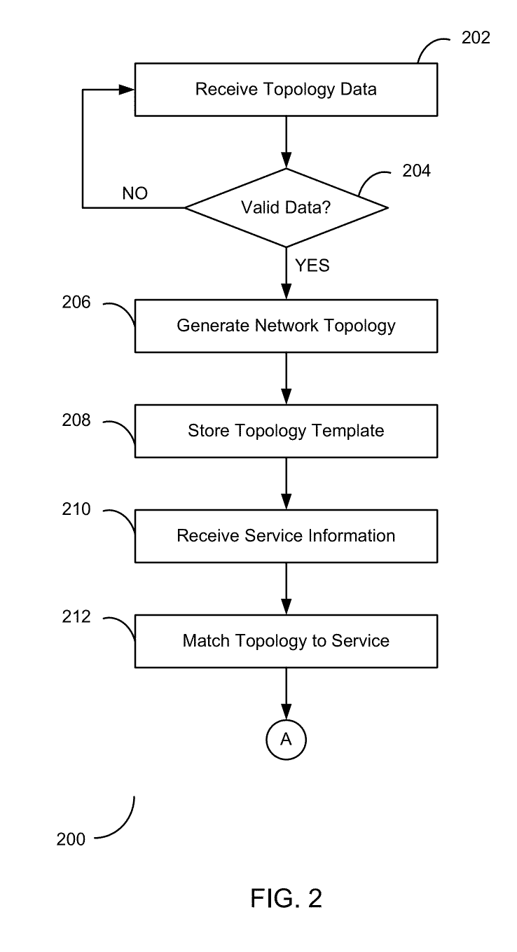

Client networks 102a-c communicate with the provider 108 via a configuration server 110. Configuration server 110 receives service information 104a-c from the networks 102a-c via network 106. Configuration server 110 may additionally receive information regarding network topology from client networks 102a-c via an interface or automated discovery mechanism. The configuration server 110 transmits the topology data to a service manager 112 which coordinates with topology storage 114 and service template storage 116. In the illustrated embodiment, service manager 112 may transform the topology data into a network topology for storage within storage 114. In one embodiment, service manager 112 receives raw network element data and generates a structured representation of the client networks 102a-c based upon the topology data as discussed more fully with respect to FIG. 2.

Service templates storage 116 contains a plurality of service templates representing potential services that may be deployed on client networks 102a-c. Service templates contain generalized information regarding the operating parameters of given service including, but not limited to, monitoring configuration for a given service. In alternative embodiments, service templates may include event filters, metric definitions with compliance levels, device information, and/or user account/contact information. For example, event filters may be utilized to indicate outage conditions, end point failures, single points of failure and other, similar metrics. Metric definitions may include key performance indicators (KPIs) and/or key quality indicators (KQIs). In one embodiment device information may comprise data relating to the hardware and/or software located on a network such as Internet Protocol (IP) addresses, DNS records, etc.

Notably, a service template does not necessarily contain details regarding specific network elements but rather contains generalized information to be applied to network elements.

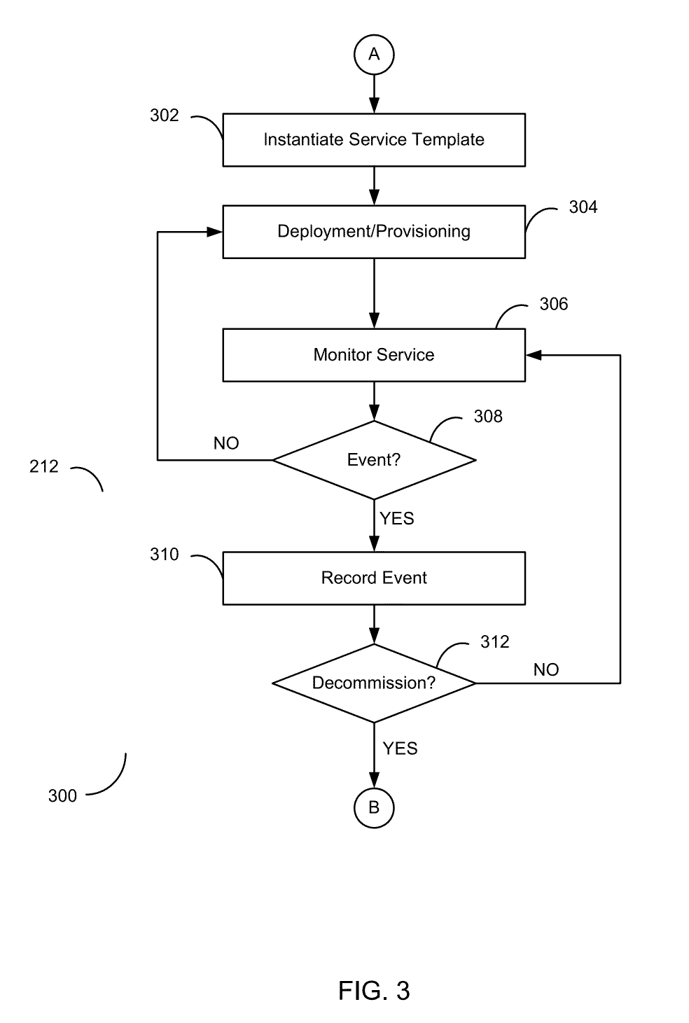

Configuration server 110 is further operative to receive service information 104a-c and a service template identifier from the client networks 102a-c. Upon receipt of the service information 104a-c, the configuration server 110 may apply a service template to the service information and instantiate an instance of the service template, as applied to the service information. Instantiation of a service template is discussed in fuller detail with respect to FIG. 3 and is not repeated here for the sake of clarity. Configuration server 110 is further operative to configure network elements within client networks 102a-c in order to deploy and provision new services defined by the service templates instances.

The provider 108 further contains a monitoring service 118. In the illustrated embodiment, the monitoring service 118 is informed of an instantiation of a service template and is operative to monitor the deployed service within the client networks 102a-c. As part of the service operation, monitoring service 118 is operative to perform active and/or passive monitoring of network elements within the client networks 102a-c. The monitoring service 118 may provide visualizations of network event, fault or other data via a reporting interface 120. In one embodiment, the reporting interface 120 may comprise a graphical user interface, such as web page, deliverable to a customer via a network 106. Although illustrated as separate from client networks 102a-c, in some embodiments, the components of provider 108 may be present within a client network 102a-c.

FIG. 2 illustrates a method for transmitting service information for a new service according to one embodiment of the disclosure. As the embodiment of FIG. 2 illustrates, the method 200 receives topology data, step 202. The method 200 may receive such data from a network administrator or other personnel responsible for maintaining and deploying network devices within a customer network. Topology data generally includes details relating to the layout and interconnections of devices and services within a network. For example, topology data may comprise endpoint data regarding the physical and logical connection of devices within a network. That is, topology data may include data regarding the OSI Layer 1 and 2 connectivity of devices within a network. Alternatively, or in conjunction with the foregoing, additional OSI Layer connectivity may be received as part of the topology data.

After receiving the data, the method 200 ensures that the data received is valid, step 204. If the data is invalid, the method 200 receives updated topology data, step 202, and continues to validate the received topology data until valid data is received. In the illustrated embodiment, validation of topology data may include validating the form and content of the received data to ensure the integrity of data that may be submitted by external users. For example, the method 200 may, at a minimum, ensure that the topology data is well-formatted according to a predefined data format.

The method 200 then generates a network topology, step 206, and stores the topology, step 208. Generating a network topology may comprise parsing the received topology data and organizing the topology data into a structured format to adequately describe the interconnections of an entire network, or partial network, described by the topology data. That is, while the topology data may comprise details regarding endpoints within a network, the method 200 utilizes this data to generate a “picture” of the network. In some embodiments, this translation may comprise generating a graph data structure describing the endpoints and their interconnections on one or more network layers (e.g., physical and application layers). In further embodiments, generating a network topology may be undertaken as part of an additional process such as deploying monitoring of a network.

After generating and storing a network topology, the method 200 receives service information, step 210. In one embodiment, receiving service information may comprise receiving data relating to a service that a network operator wishes to deploy. For example, service information may comprise data such as a customer identifier and associated metadata, a service identifier and associated metadata, service levels, customer access information, and network endpoints associated with the service. Notably, service information is not utilized by the customer to manually configure the network to handle the new service, rather, such data is received by the method 200 which acts as a broker to deploy said service, reducing the overhead incurred by the network operator in deploying new services.

The method 200 then attempts to match the service information with the stored network topology, step 212. In one embodiment, the method 200 may utilize service templates in order to determine a match between the service information and the network topology. In one embodiment, a customer of the method 200 may transmit service information according a predefined template. For example, if a service template exists for a telephony service, a customer may select such template and provide service information including routers, switches, and other devices associated with the service. Notably, the method 200 does not require all details regarding the service, but only requires service-specific data, such as endpoints, as the service template contains the deployment details for the type of service requested by the user.

FIG. 3 illustrates a method for deploying a network service according to one embodiment of the disclosure. As discussed with respect to FIG. 2, a network operator transmits service information which, in turn, is matched with a predefined service template.

After a match is found for the service information and requested template, the method 300 instantiates a service template based on the received data, step 302. In one embodiment instantiating a template involves applying the service information to a predefined service template. That is, a service template may provide the details and deployment requirements of a predefined service, but may require the service information to fully describe the service. For example, a service template may define the configuration of types of devices and monitoring constraints, but may not contain a list of devices utilized in the service. When a template is instantiated, a new instance of the template is created that contains the list of endpoints specified in the service information to generate a full picture of the service. In one embodiment, an instantiation of a template includes information including the name of the service, customer information, and compliance information. Additionally, an instantiation may include one or more sub-services, a compliance level (e.g., operational level agreement (OLA) and/or service level objective (SLO)), and status indicators. In one embodiment, sub-services, compliance levels, and status indicators may be combined as needed by the customer.

The method 300 then deploys and provisions the service, step 304. As discussed previously, the method 300 instantiates a new instance of service template using the supplied service information, step 302. The method 300 utilizes this instance of the service template to actively configure devices on the network to implement the service. In one embodiment, the method 300 may utilize the endpoint data (from the service information) and the endpoint configuration data (from the template) to identify the network elements (e.g., using SNMP) and configure the network elements to function within the service parameters. For example, the method 300 may configure the network elements to accept certain types of traffic and guarantee requested service levels requested by the customer. The method 300 may additionally set an activation data and/or time wherein the configuration is delayed until such a date and/or time. The method 300 may additionally configure network elements to handle the parsing of requests in various protocols, feeds, or formats. The method 300 may additionally notify the customer upon the successfully activation of the service and provide information (such as portal information) that allows the customer to monitor, update, or add new functionality to the service. Additionally, the method 300 may automatically configure active and/or passive monitoring of the elements and the newly deployed service.

The method 300 then monitors the deployed service, step 306, and records events, step 310 if an event occurs, step 308. As discussed previously, as part of deploying the service, the method 300 may configure active and/or passive monitoring of the service and the associated network elements. As part of this process, the method 300 may configure the service to monitor events and other data that occur as part of the service operation. In one embodiment, the method 300 may utilize an existing monitoring infrastructure thus providing a unified monitoring interface with other monitoring performed for the customer. When events occur with respect to the service, the method 300 records said events and processes the events to provide a visualization of activity and events within the network and associated with the service. These visualizations may be provided via a reporting interface. In one embodiment, the visualizations may be provided within a customer portal as described previously.

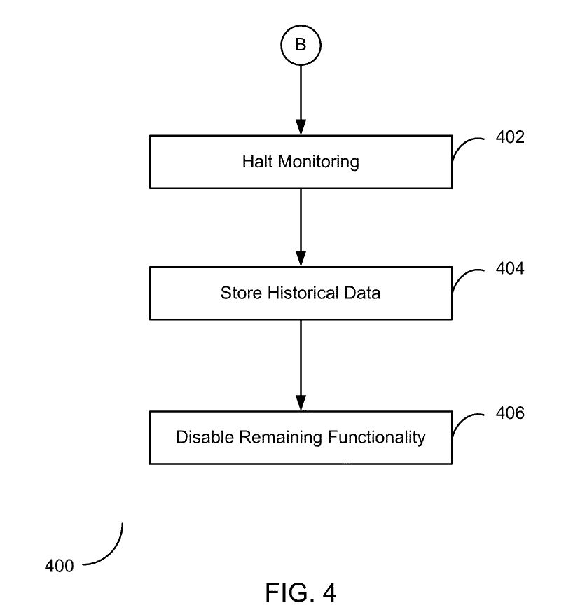

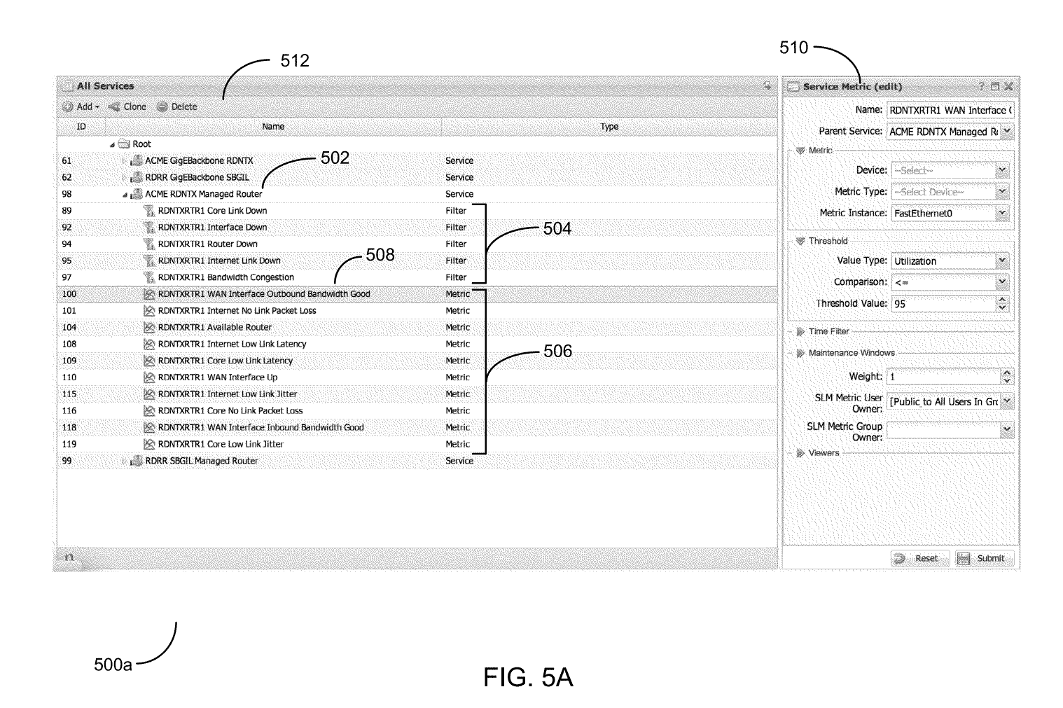

The method 300 additionally determines if a decommissioning request is received, step 312. The method 300 will continue monitoring the service, step 306, unless a decommissioning request is received. If, however, such a request is received, the method 300 will decommission the service as described more fully with respect to FIG. 4.

FIG. 4 illustrates a method for decommissioning a service according to one embodiment of the disclosure. As discussed with respect to FIG. 3, a customer may decide to decommission a service deployed in accordance with FIGS. 2 and 3.

Upon detecting the request for decommissioning, the method 400 first halts all monitoring of the service, step 402. In one embodiment, halting monitoring may comprise identifying the network elements associated with the service and halting monitoring for the service utilized by the network element.

The method 400 then stores historical data associated with the service, step 404. As discussed previously, various data points and event data is collected during the lifetime of the service to visualize the service performance and any faults or other issues that arise during the lifetime of the service. In one embodiment, when the service is decommissioned, the method 400 stores this data in long term storage thus allowing for access to the monitoring data after the service has been decommissioned. Such storage allows for analysis of the service performance after the service has been decommissioned to allow for “post mortem” analyses that may provide valuable information for future services deployed on the network.

Finally, the method 400 disables any remaining functionality, step 406. As part of this process, the method 400 may disable any aspects of the network elements utilized solely by the service, or modify those aspects to “rollback” the configuration of the network elements configuration. Additionally, the method 400 may disable the customer portal discussed previously, or may migrate the customer portal to a separate “long term” portal configuration.

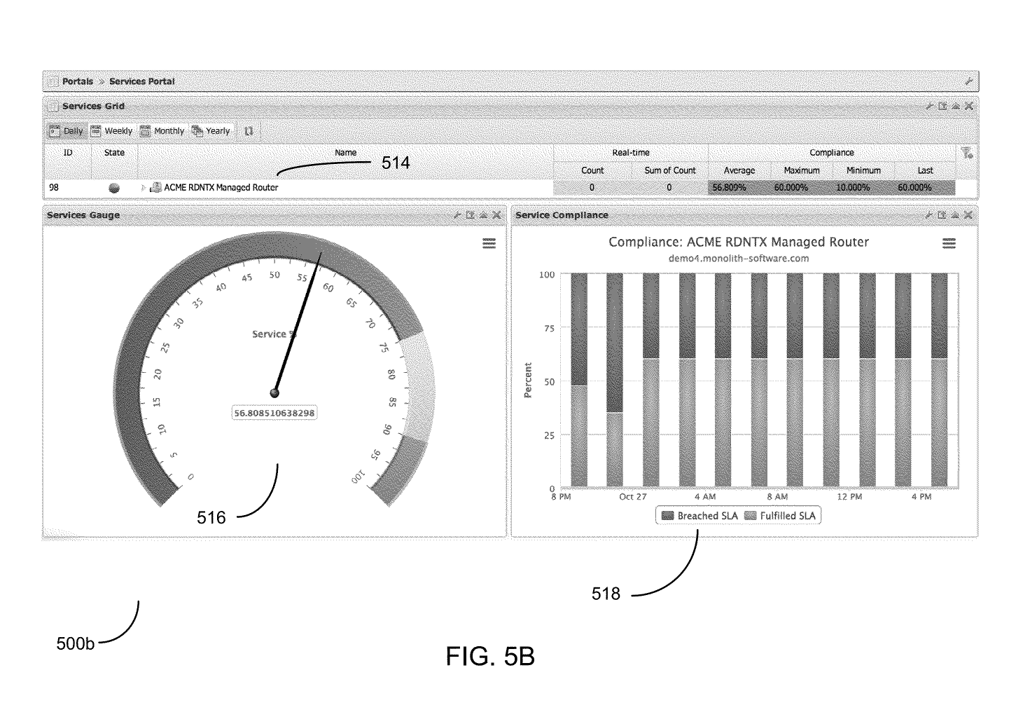

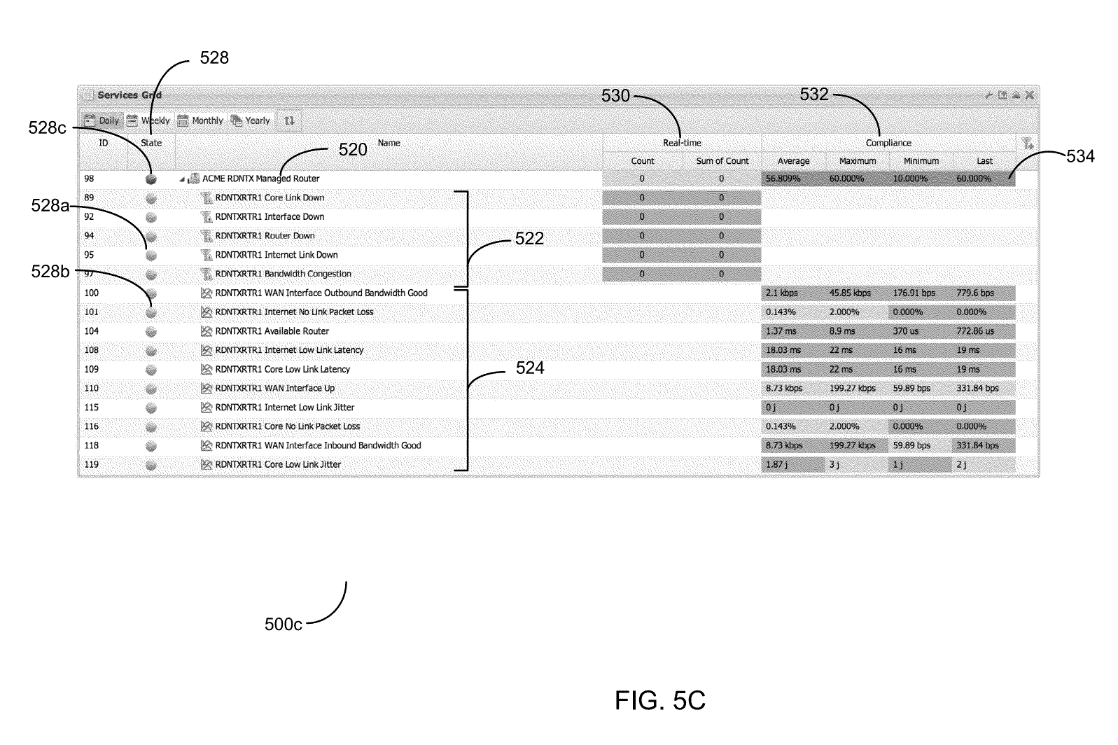

FIG. 5A illustrates a graphical user interface 500a for instantiating a service template according to one embodiment of the present invention. User interface 500a illustrates a plurality of instantiations including a “managed router” template instantiation 502. The instantiation 502 comprises a plurality of filters 504 and metrics 506.

If a user selects a one of the filters 504 or metrics 506, the user interface 500a may display an editing panel 510 to allow for modification or creation of the filters 504 or metrics 506. For example, in the user interface 502a depicted, a “WAN Interface Outbound Bandwidth Good” metric 508 is selected. In response, the editing panel 510 displays a plurality of metric parameters that may be configured for the selected metric 508.

The editing panel 510 depicts one embodiment of the template parameters that may be modified. As illustrated, the metric 508 may have a name and parent service property that allows for identification of the metric and an indication of which instantiation the metric belongs to, respectively. Notably, the user may be able to rename the metric as they see fit but may be limited to selecting an existing parent service.

The editing panel 510 further comprises a plurality of fields relating to metric properties including a device, metric type, and metric instance field. In one embodiment, these properties may be automatically completed based on the configuration of the template. In one embodiment, the device may be selected upon instantiation of the template, thus allowing for reuse of the template with multiple devices.

The editing panel 510 further contains a plurality of threshold fields including a value type, comparison, and threshold value field. These fields may define the type of monitoring that will be deployed with the associated filter or metric. In the selected metric 508 illustrated, the metric 508 has been designed to monitor the utilization of the network device (“Value Type” set to “Utilization”). The comparison may be set to a comparative operator, for example, less than or equal to as illustrated, while alternative comparisons may be utilized as well. Finally, the metric sets the threshold value, corresponding to the target value of the comparison. Taken together, the illustrated metric monitors the bandwidth utilization of the managed router to determine if the utilization is less than or equal to 95 percent.

Additionally illustrated in editing panel 510 are time filter properties, maintenance window properties, and viewers properties. In one embodiment these properties represent service level details required for the service. For example, time filter may comprise details regarding the guaranteed operating time for the service (e.g., 9 AM to 5 PM). Maintenance windows may provide details on notifications regarding maintenance periods defined under an SLA. The viewers metric may relate to SLA multi-tenancy.

FIG. 5B illustrates a graphical user interface 500b providing a graphical overview of a monitoring service for a service 514. As the embodiment of FIG. 5B illustrates, a GUI 500b may comprise a services gauge 516 providing high-level details regarding the performance of the selected service 514. For example, gauge 516 may depict an aggregated overview of the performance of a service 514 based on the underlying, detailed metrics and filters described more fully with respect to FIG. 5C.

GUI 500b may further include a service compliance window 518 that illustrates the percentage of an SLA associated with the service complied with. In the illustrated embodiment, the lower portion of the graph may illustrate fulfilled SLA percentage while the upper portion may depict the percentage of SLA breaches.

FIG. 5C illustrates a graphical user interface 500c illustrated a detailed view of metrics and filters for a given service 520. As in FIG. 5A, the GUI 500c illustrates a plurality of metrics 524 and filters 522 associated with the server 520. Additionally, the GUI 500c may provide a status indicator 528 that illustrates the status of the filter or metric. For example, the metric “RDNTXRTR1 Available Router” may have a green status indicator 528a representing a positive metric whereas the metric “RDNTXRTR1 WAN Interface Up” may have a yellow indicator 528b representing a problematic metric. A combination of positive and negative statuses may be aggregated to depict an overall status 528c. In one embodiment, this status indicator 528c may be red, indicating potential issues, if any of the filter or metric status are not positive. Alternatively, status indicator 528c may only indicate a negative monitoring condition if a predefined number of filters or metrics are indicating negative results.

GUI 500c further comprises a real-time event panel 530 and a compliance panel 532. As illustrated in FIG. 5C, real-time event panel 530 may present the number of events that have occurred for a given filter. For example, a count may be incremented if an interface of the managed router is down. Event counts may be aggregated over a pre-defined period of time and may be reset or flushed upon the occurrence of a predefined condition. Notably, as indicated in FIG. 5C real-time event panel 530 may only display event counts for filters 522 as event counts are not applicable to metrics 524. In the illustrated event panel 530, the “count” property may correspond to how many events are occurring and a given time. The “sum of count” property may correspond to an aggregated number of events. In one embodiment, the sum of count property allows the GUI 500c to provide details regarding long-term problems such as filters repeatedly “going down” while the count property provides insight into the live state of the filter.

GUI 500c may further include a compliance panel 532. In the illustrated embodiment, compliance panel 532 indicates an average, maximum, minimum, and last recorded value for the metrics 524 associated with a service 520. As illustrated, the numerical values in compliance panel 532 may change depending on the metric monitored. For example, a bandwidth measurement may be expressed in kilobits per second whereas packet loss may be expressed as a percentage. Further, the GUI 500c may additionally comprise an aggregated compliance indicator 534 that aggregates the individual filter compliance data into a single percentage passed representation. In the illustrated embodiment, the aggregated indicator may normalize the metrics below to generate an SLA compliance percentage illustrated as element 534.

FIGS. 1 through 4B are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a non-transitory machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to non-transitory media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for automatically propagating service definitions from service fulfillment platforms, the method comprising:
receiving service information associated with a new service;
receiving one or more service templates;
identifying a service template associated with the service information;
instantiating the service template and deploying the service associated with the service information;
configuring monitoring for the service associated with the service information based on the instantiated service template; and
generating monitoring information for the service associated with the service information.

2. The method of claim 1 wherein service information comprises one of a customer identifier, service identifier, service levels, customer access information to portals, end point data, and metadata relating to a service.

3. The method of claim 1 wherein identifying a service template associated with the service information comprises matching a network topology to the type of service identified by the service information.

4. The method of claim 1 wherein the monitoring comprises passive or active monitoring.

5. The method of claim 1 further comprising receiving a decommissioning request for the new service and terminating said monitoring.

6. The method of claim 5 wherein terminating said monitoring further comprises storing historical monitoring data.

7. A system for automatically propagating service definitions from service fulfillment platforms, the system comprising:
a service template storage module for storing service templates;
a generating monitoring information for the service associated with the service information
a configuration server for
receiving service information;
receiving one or more service templates;
identifying a service template associated with the service information;
instantiating the service template and deploying the service associated with the service information; and
configuring monitoring for the service associated with the service information

8. The system of claim 7 wherein service information comprises one of a customer identifier, service identifier, service levels, customer access information to portals, end point data, and metadata relating to a service.

9. The system of claim 7 wherein identifying a service template associated with the service information comprises matching a network topology to the type of service identified by the service information.

10. The system of claim 7 wherein the monitoring comprises passive or active monitoring.

11. The system of claim 7 further comprising receiving a decommissioning request for the new service and terminating said monitoring.

12. The system of claim 11 wherein terminating said monitoring further comprises storing historical monitoring data.

13. Non-transitory computer readable media comprising program code that when executed by a programmable processor causes execution of a method for automatically propagating service definitions from service fulfillment platforms, the computer readable media comprising:
computer program code for receiving service information;
computer program code for receiving one or more service templates in response to receiving service information;
computer program code for identifying a service template associated with the service information;
computer program code for instantiating the service template and deploying the service associated with the service information;
computer program code for configuring monitoring for the service associated with the service information; and
computer program code for generating monitoring information for the service associated with the service information.

14. The computer readable medium of claim 13 wherein service information comprises one of a customer identifier, service identifier, service levels, customer access information to portals, end point data, and metadata relating to a service.

15. The computer readable medium of claim 13 wherein identifying a service template associated with the service information comprises matching a network topology to the type of service identified by the service information.

16. The computer readable medium of claim 13 wherein identifying a service template associated with the service information comprises matching a network topology to the type of service identified by the service information.

17. The computer readable medium of claim 13 wherein the monitoring comprises passive or active monitoring.

18. The computer readable medium of claim 13 further comprising computer program code for receiving a decommissioning request for the new service and terminating said monitoring.

19. The computer readable medium of claim 18 wherein terminating said monitoring further comprises storing historical monitoring data.
